(19) United States
(12) Patent Application Publication
(10) Pub. No.: US 2026/0128595 A1
(43) Pub. Date: May 7, 2026

(54) OPTIMIZATION SCHEDULING METHOD AND SYSTEM FOR COUPLING MICROGRID CONSIDERING ELECTRO-THERMAL LOAD DEMAND COORDINATION

(71) Applicant: SHANDONG UNIVERSITY, Jinan (CN)

(72) Inventors: Tianguang LU, Jinan (CN); Yuhao ZHANG, Jinan (CN); Yansong MEI, Jinan (CN); Qian AI, Jinan (CN); Xing HE, Jinan (CN); Donglei SUN, Jinan (CN); Ming YANG, Jinan (CN); Qinzheng WU, Jinan (CN); Yingdong XU, Jinan (CN)

(21) Appl. No.: 19/380,504

(22) Filed: Nov. 5, 2025

(30) Foreign Application Priority Data
Nov. 7, 2024 (CN) 2024115785427

(51) Int. Cl. H02J 3/46; F24D 18/00; G06Q 50/06; H02J 15/00

(52) U.S. Cl. CPC H02J 3/466; F24D 18/00; G06Q 50/06; H02J 15/50; H02J 2101/24; H02J 2101/28; H02J 2101/30; H02J 2101/40; H02J 2103/30

(57) ABSTRACT

An optimization scheduling method for coupling microgrid considering electro-thermal load demand coordination, comprising: building hydrogen-containing microgrid operation model and building electro-thermal load demand coordination response model by considering peak-valley complementary characteristics of original electric load and thermal load in system, characterizing electric load by time-of-use electricity price demand response method, by considering thermal load having heat transfer inertia and fuzziness of user temperature perception, adjusting electro-thermal load demand flexibly based on different electricity prices; based on hydrogen-containing microgrid operation model and electro-thermal load demand coordination response model, building objective function by minimizing sum of total operation cost, wind and light curtailed cost of renewable energy and demand response compensation cost, building electro-hydrogen coupling microgrid optimal scheduling model according to constraint conditions and solving it by mixed integer linear programming, to generate and send instructions based on solved optimal operation scheduling strategy to the microgrid for controlling corresponding unit equipment operation.

### CROSS-REFERENCE TO RELATED APPLICATIONS

The present invention claims priority from China patent application filed on Nov. 7, 2024 in China National Intellectual Property Administration with application No. 202411578542.7 entitled “Optimization Scheduling Method and System for Coupling Microgrid Considering Electro-thermal Load Demand Coordination,” the entire contents of which are incorporated herein by reference and constitute a part of the present invention for all purposes.

### TECHNICAL FIELD

The present invention relates to the technical field of optimization scheduling of microgrid, in particular to an optimization scheduling method and system for a coupling microgrid considering electro-thermal load demand coordination.

### BACKGROUND

The statements in this section merely provide background information related to the present invention and are not necessarily prior art.

At present, fossil energy represented by coal and oil will be gradually replaced by renewable energy represented by wind power. Hydrogen, as an important green and clean renewable energy, is considered to have broad prospects for development because of its advantages of high energy, zero carbon emission and high energy conversion efficiency. With the continuous progress of energy technology, hydrogen-containing microgrid, as a new type of energy network that can realize electro-hydrogen conversion, shows great application potential in multi-energy conversion and storage, resource optimization allocation and so on. The power grid can not only make full use of distributed renewable energy, reduce dependence on traditional fossil energy, but also solve the problem of unstable output of renewable energy such as wind power and photovoltaic through efficient storage and utilization of hydrogen, and effectively solve the problem of supply of different types of energy such as electric energy and thermal energy.

However, due to the preliminary study of electro-hydrogen coupling microgrid, it faces the problems of complex equipment operation and changeable user demand in the actual application scheduling process. In order to solve the above problems, the existing methods deeply dig and predict the user's electricity consumption behavior by introducing optimization algorithms and combining big data analysis and machine learning technologies, and realize real-time monitoring and dynamic adjustment of the microgrid operation state. Based on evolutionary particle swarm optimization algorithm, the existing methods improve genetic algorithm, gray wolf algorithm and other optimization algorithms to solve the problem of optimal configuration and technical and economic analysis of the electro-hydrogen coupling microgrid; based on big data analysis technology to monitor and analyze the power production, conversion and storage data of distributed power sources in microgrid, the existing methods realize intelligent energy scheduling and management, and help complete fault diagnosis and maintenance; based on machine learning technology, load demand, weather information, user behavior, and market price predictions, the existing methods realize to help plan energy production and distribution.

However, most of the researches on optimization operation of the microgrid focus on improving renewable energy efficiency and controlling the operation and maintenance costs of microgrid and pollution control costs, without considering the behavior of users to adjust power consumption time and demand to participate in microgrid operation optimization. In addition, at present, the optimal dispatching strategy of electro-hydrogen coupling microgrid often only considers the dispatching planning of electro-hydrogen conversion equipment units, and has not considered renewable energy generators such as wind power generator units and photovoltaic generators, which has limitations in decision-making.

### SUMMARY

To solve the above problems, the present invention provides an optimization scheduling method and system for a coupling microgrid considering electro-thermal load demand coordination, which considers the correlation characteristic of electric-heat-gas-hydrogen multi-energy conversion of new energy output property and the peak-valley complementary characteristic of original electric load and thermal load in the system on time distribution, firstly, electric load demand response research is carried out by using a time-sharing electricity price demand response method, and then flexible adjustment is carried out by considering the fuzziness of heat transfer inertia and user temperature perception of thermal load, An optimal scheduling model for hydrogen-containing microgrid is established to optimize the output level of each device in the system to ensure that the microgrid operates in an efficient and environmentally friendly state.

According to some embodiments, the present invention adopts the following technical solutions.

An optimization scheduling method for a coupling microgrid considering electro-thermal load demand coordination, comprising:
building a hydrogen-containing microgrid operation model based on operation characteristics and interaction of new energy generating units, electro-hydrogen coupling units, heat generating units and energy storage units;
building an electro-thermal load demand coordination response model by considering peak-valley complementary characteristics of an original electric load and a thermal load in system, wherein characterizing an electric load by a time-of-use price demand response method, by considering a thermal load has heat transfer inertia and fuzziness of user temperature perception, adjusting electro-thermal load demand flexibly based on different electricity prices; and
based on the hydrogen-containing microgrid operation model and the electro-thermal load demand coordination response model, building an objective function with an objective of minimizing a sum of a total operation cost of a microgrid in the future, a wind and light curtailed cost of renewable energy and a demand response compensation cost, building an electro-hydrogen coupling microgrid optimal scheduling model according to constraint conditions, then solving the electro-hydrogen coupling microgrid optimal scheduling model by a mixed integer linear programming, generating control instructions for optimizing operations of each unit equipment in an electro-hydrogen coupling microgrid in the future and sending the control instructions to the each unit equipment and corresponding regulation equipment in the electro-hydrogen coupling microgrid, and controlling the each unit equipment and the corresponding regulation equipment to perform operation and output according to an optimal operation scheduling strategy in the control instructions, so as to realize the optimization scheduling of the electro-hydrogen coupling microgrid considering the electro-thermal load demand coordination.

According to some embodiments, the present disclosure adopts the following technical solutions.

An optimization scheduling system for a coupling microgrid considering electro-thermal load demand coordination, comprising:
a model building module, for building a hydrogen-containing microgrid operation model based on operation characteristics and interaction of new energy generating units, electro-hydrogen coupling units, heat generating units and energy storage units; and, building an electro-thermal load demand coordination response model by considering peak-valley complementary characteristics of an original electric load and a thermal load in system;
a demand coordination response optimization module, for characterizing an electric load by a time-of-use price demand response method, by considering a thermal load has heat transfer inertia and fuzziness of user temperature perception, adjusting electro-thermal load demand flexibly based on different electricity prices; and
an operation scheduling module, for based on the hydrogen-containing microgrid operation model and the electro-thermal load demand coordination response model, building an objective function with an objective of minimizing a sum of a total operation cost of a microgrid in the future, a wind and light curtailed cost of renewable energy and a demand response compensation cost, building an electro-hydrogen coupling microgrid optimal scheduling model according to constraint conditions, then solving the electro-hydrogen coupling microgrid optimal scheduling model by a mixed integer linear programming (MILP), generating control instructions for optimizing operations of each unit equipment in an electro-hydrogen coupling microgrid in the future and sending the control instructions to the each unit equipment and corresponding regulation equipment in the electro-hydrogen coupling microgrid, and controlling the each unit equipment and the corresponding regulation equipment to perform operation and output according to an optimal operation scheduling strategy in the control instructions, so as to realize the optimization scheduling of the coupling microgrid considering the electro-thermal load demand coordination.

According to some embodiments, the present invention adopts the following technical solutions.

A non-transitory computer-readable storage medium, having computer instructions stored thereon, wherein when the computer instructions are executed by a processor, causing the processor to implement the optimization scheduling method for the coupling microgrid considering electro-thermal load demand coordination.

According to some embodiments, the present invention adopts the following technical solutions.

An electronic device, comprising a processor, a memory and a computer program, wherein the processor is connecting to the memory, the computer program is stored in the memory, and when the electronic device runs, the processor executes the computer program stored in the memory, so as to enable the electronic device to execute the optimization scheduling method for the coupling microgrid considering electro-thermal load demand coordination.

Compared with the prior art, the beneficial effects of the present invention are as follows:

According to the optimization scheduling method for the coupling microgrid considering electro-thermal load demand coordination, firstly, the related characteristics of the electric, thermal, gas and hydrogen multi-energy conversion of the output property of the new energy are fully considered, and the hydrogen-containing microgrid operation model is constructed based on the operation characteristics and the interaction influence of the new energy generator set, the electro-hydrogen coupling unit, the heat generating unit and the energy storage unit. On the premise of ensuring the stable operation of the microgrid, this model promotes the comprehensive utilization of electric heating, gas and hydrogen energy, and further improves the overall operating efficiency of the energy system.

According to the optimization scheduling method for the coupling microgrid considering electro-thermal load demand coordination, considering the peak-valley complementary characteristics of the original electric load and the thermal load in the system in terms of time distribution, and proposes a coordinated response to the electric and thermal load demands to improve the transfer potential between the electric load and the thermal load. Firstly, the time-of-use tariff demand response method is used to study the load demand response, and then the thermal load is adjusted flexibly based on different tariffs considering the heat transfer inertia and the fuzziness of user temperature perception. Through the coordinated response of electro-thermal load, the internal energy of the system can be utilized more efficiently while reducing the operating cost and the stability of the system operation can be improved.

According to the optimization scheduling method for the coupling microgrid considering electro-thermal load demand coordination, taking the minimum sum of the total system operation cost, the wind and light curtailed cost of renewable energy and the demand response compensation cost as an objective function to build a hydrogen-containing microgrid optimization scheduling model. Based on the hydrogen microgrid operation model and the electro-thermal load demand coordination response model, the model comprehensively optimizes the operation output level of each device in the system to ensure that the microgrid operates in an efficient and environmentally friendly state. Finally, the model is transformed into MILP model by piecewise linearization, and solved by commercial solver CPLEX. The optimal operation strategy is obtained and sent to corresponding equipment for execution in time, which reduces the operation cost of microgrid and improves the operation efficiency and stability of power system.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a framework diagram of an electro-thermal load demand coordination response strategy according to an example of the present invention.

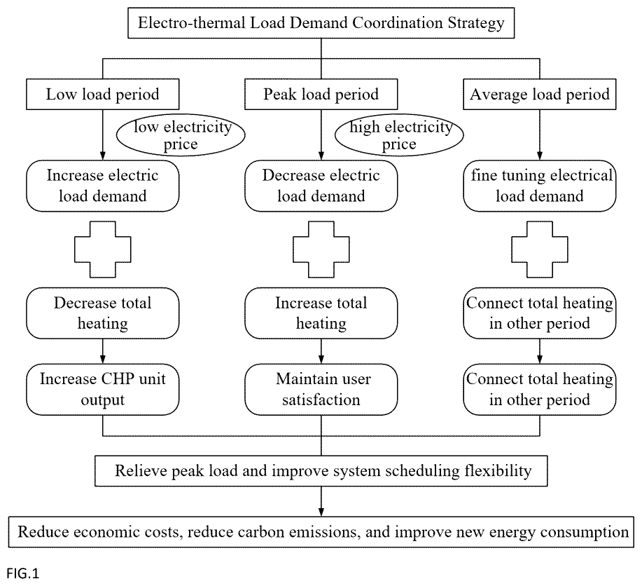

FIG. 2 is a framework diagram for solving an operation of a hydrogen-containing microgrid according to an example of the present invention.

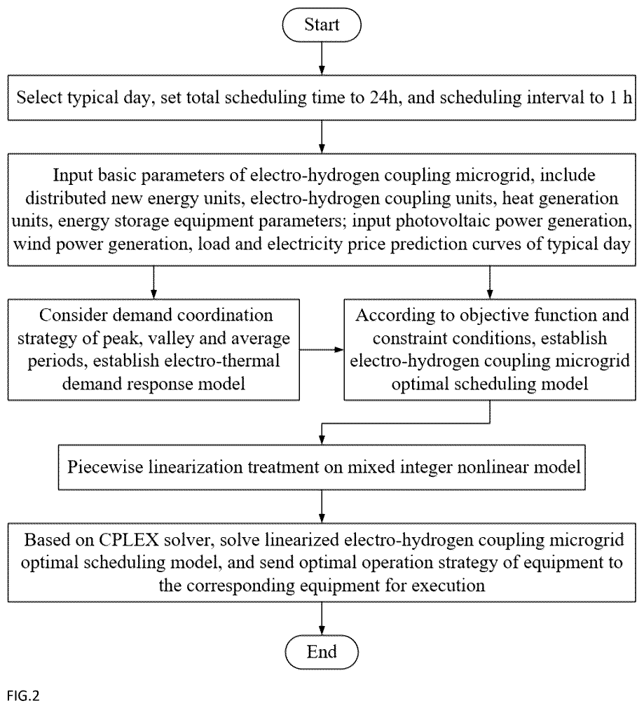

### DETAILED DESCRIPTION

The present invention will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, terms “comprise/comprising” and/or “include/including” used in this specification indicate that there are features, steps, operations, devices, components, and/or combinations thereof.

### Example 1

The present example of the invention provides an optimization scheduling method for a coupling microgrid considering electro-thermal load demand coordination, comprising the following steps:

step 1: building a hydrogen-containing microgrid operation model based on operation characteristics and interaction of new energy generating units, electro-hydrogen coupling units, heat generating units and energy storage units;

step 2: building an electro-thermal load demand coordination response model by considering peak-valley complementary characteristics of an original electric load and a thermal load in system, wherein characterizing an electric load by a time-of-use price demand response method, by considering a thermal load has heat transfer inertia and fuzziness of user temperature perception, adjusting electro-thermal load demand flexibly based on different electricity prices; and

step 3: based on the hydrogen-containing microgrid operation model and the electro-thermal load demand coordination response model, building an objective function with an objective of minimizing a sum of a total operation cost of a microgrid in the future, a wind and light curtailed cost of renewable energy and a demand response compensation cost, building an electro-hydrogen coupling microgrid optimal scheduling model according to constraint conditions, then solving the electro-hydrogen coupling microgrid optimal scheduling model by a mixed integer linear programming, generating control instructions for optimizing operations of each unit equipment in an electro-hydrogen coupling microgrid in the future and sending the control instructions to the each unit equipment and corresponding regulation equipment in the electro-hydrogen coupling microgrid, and controlling the each unit equipment and the corresponding regulation equipment to perform operation and output according to an optimal operation scheduling strategy in the control instructions, so as to realize the optimization scheduling of the coupling microgrid considering the electro-thermal load demand coordination.

As the example, the optimization scheduling method for a coupling microgrid considering electro-thermal load demand coordination disclosed in the present invention, comprising the following specific implementation process.

Step 1: building the hydrogen-containing microgrid operation model based on the operation characteristics and the interaction of the new energy generating units, the electro-hydrogen coupling units, the heat generating units and the energy storage units.

Specifically, the microgrid integrating four energy forms of electricity, heat, gas and hydrogen, meets internal energy demand by dispatching a variety of energy sources and functional equipment. The designed microgrid architecture in the present invention comprises a distributed new energy unit, a combined heat and power (CHP) unit, an electrolytic cell model, a methane reactor model, a hydrogen fuel cell model and an energy storage model;
the hydrogen-containing microgrid operation model comprise a distributed new energy generating unit model, an electro-hydrogen couple unit model, a heat generating unit model and an energy storage model, wherein the distributed new energy generating unit model comprise a wind power generator unit and a photovoltaic generating unit; the electro-hydrogen coupling unit model comprises the electrolytic cell model, the methane reactor model and the hydrogen fuel cell model; the heat generating unit model comprises the CHP unit and a gas-fired boiler model; and, the energy storage model is a unified modeling of four energy devices: electricity, heat, gas, and hydrogen. These include the following:

### Step 1.1 Modeling of Distributed New Energy Units

### Step 1.1.1 Photovoltaic Generator Unit

By ignoring the effect of temperature, the power generated by the photovoltaic generator set can be calculated as:

$${P}_{PV , t}^{e} = {f}_{PV} {C}_{PV} \frac{{G}_{t}}{{G}_{STC}} \qquad ( 1 )$$

wherein,

$${P}_{PV , t}^{e}$$

is the generated power of the photovoltaic generator unit, f_{PV} is the efficiency of the photovoltaic system, C_{PV} is the rated photovoltaic power, Gₜ is the total irradiance actually incident on the photovoltaic array by the sun, and G_{STC} is the total irradiance incident on the photovoltaic array by the sun under standard test conditions.

### Step 1.1.2 Wind Power Generator Unit

The relationship between the power generation of the wind power generator unit and wind speed is as follows:

$${P}_{WT , t}^{e} = \{ \begin{matrix}0 & u ( t ) \leq {u}_{c} ‖ {u}_{t} \geq {u}_{f} \\ {C}_{WT} \times \frac{{u}_{t} - {u}_{c}}{{u}_{r} - {u}_{c}} & {u}_{c} \leq {u}_{t} \leq {u}_{r} \\ {C}_{WT} & {u}_{r} \leq {u}_{t} \leq {u}_{f}\end{matrix} \qquad ( 2 )$$

wherein,

$${P}_{WT , t}^{e}$$

is the generating power of the wind power generator unit, uₜ is the wind speed, C_{WT} is the rated power of the wind power generator unit, uᵣ is the rated wind speed, u_{c} and u_{f} are the cut-in wind speed and cut-off wind speed respectively.

### Step 1.2 Modeling of Electro-Hydrogen Coupling Unit

### Step 1.2.1 Electrolytic Cell Model

The traditional hydrogen production mainly depends on fossil fuels. With the implementation of a double-carbon (carbonneutrality and peak-carbon-dioxide-emission) strategy, the application range of hydrogen production by electrolysis of water is gradually expanded, and proton exchange membrane hydrogen production technology occupies the mainstream among a number of hydrogen production technology routes. The method uses a proton exchange membrane to separate hydrogen ions from electrons in water molecules, thereby generating pure hydrogen gas. The power of the hydrogen generated by the electrolytic cell unit is shown below:

$${P}_{EL , t}^{{H}_{2}} = {η}_{EL} {P}_{EL , t}^{e} \qquad ( 3 )$$

wherein,

$${P}_{EL , t}^{e}$$

is the electric power input to the electrolytic cell unit model,

$${P}_{EL , t}^{{H}_{2}}$$

is the hydrogen power output from the electrolytic cell unit model, and η_{EL} is the energy conversion efficiency of the electrolytic cell unit model.

### Step 1.2.2 Methane Reactor Model

The methane reactor outputs natural gas to the CHP unit and gas-fired boiler model by burning hydrogen. The natural gas power output from the methane reactor is as follows:

$${P}_{MR , t}^{g} = {η}_{MR} {P}_{MR , t}^{{H}_{2}} \qquad ( 4 )$$

wherein,

$${P}_{MR , t}^{{H}_{2}}$$

is hydrogen power input to the methane reactor model,

$${P}_{MR , t}^{g}$$

is natural gas power output from the methane reactor model, and η_{MR} is energy conversion efficiency of the methane reactor.

### Step 1.2.3 Hydrogen Fuel Cell Model

The hydrogen fuel cell can realize the coupling between hydrogen energy and heat energy and electric energy. The specific output heat energy power and electric energy power are shown as follows:

$$\{ \begin{matrix}{P}_{HFC , t}^{e} = {η}_{HFC}^{e} {P}_{HFC , t}^{{H}_{2}} \\ {P}_{HFC , t}^{h} = {η}_{HFC}^{h} {P}_{HFC , t}^{{H}_{2}}\end{matrix} \qquad ( 5 )$$

wherein,

$${P}_{HFC , t}^{{H}_{2}}$$

is the hydrogen power input to the hydrogen fuel cell,

$${P}_{HFC , t}^{e} and {P}_{HFC , t}^{h}$$

are respectively the electrical and thermal power output by the hydrogen fuel cell, and

$${η}_{HFC}^{e} and {η}_{HFC}^{h}$$

are the efficiencies of the hydrogen fuel cell to convert electrical and thermal power respectively.

### Step 1.3 Modeling of the CHP Unit

### Step 1.3.1 CHP Unit

The CHP unit generates electricity by burning natural gas, and supplies the waste heat generated in the power generation process to the heat load. The CHP unit with adjustable thermoelectric ratio can adjust the electric and thermal output according to the real-time electric and thermal energy demand to further optimize the operation benefit. A working model thereof is shown as follows:

$$\{ \begin{matrix}{P}_{CHP , t}^{e} = {η}_{CHP}^{e} {P}_{CHP , t}^{g} \\ {P}_{CHP , t}^{h} = {η}_{CHP}^{h} {P}_{CHP , t}^{g}\end{matrix} \qquad ( 6 )$$

wherein,

$${P}_{CHP , t}^{g}$$

is the natural gas power input to the CHP unit,

$${P}_{CHP , t}^{e} and {P}_{CHP , t}^{h}$$

are respectively the electrical and thermal power output by the CHP unit, and

$${η}_{CHP}^{e} and {η}_{CHP}^{h}$$

are the efficiencies converted into electrical and thermal power by the CHP unit.

### Step 1.3.2 Gas-Fired Boiler Model

The gas-fired boiler model provides thermal energy for burning natural gas. The thermal energy power is shown as follows:

$${P}_{GB , t}^{h} = {η}_{G B} {P}_{G B , t}^{g} \qquad ( 7 )$$

wherein,

$${P}_{G B , t}^{g}$$

is the gas energy power input to the gas boiler during a “t” period,

$${P}_{G B , t}^{h}$$

is the thermal energy power output by the gas boiler during the “t” period, and η_{GB} is the energy conversion efficiency of the gas-fired boiler.

### Step 1.4 Energy Storage Model

For the unified modeling of energy storage equipment of electricity, heat, gas and hydrogen, the formula is as follows:

$$\{ \begin{matrix}{P}_{E S , t}^{n} = {P}_{ES , t}^{c h a , n} {η}_{E S}^{c h a , n} - {P}_{ES , t}^{d is , n} / {η}_{E S}^{d i s , n} \\ {S}_{n , t} = {S}_{n , ( t - 1 )} + {P}_{E S , t}^{n} / {P}_{E S}^{c a p , n} \\ {S}_{n , 1} = {S}_{n , T} \\ {B}_{ES , t}^{c h a , n} + {B}_{ES , t}^{d is , n} = 1\end{matrix} \qquad ( 8 )$$

wherein,

$${P}_{ES , t}^{c h a , n} and {P}_{ES , t}^{d is , n}$$

are respectively the charging and discharging powers of the n-th type of the energy storage device in the “t” period,

$${B}_{ES , t}^{c ha , n} and {B}_{ES , t}^{d is , n}$$

are binary variables in the “t” period and are respectively the charging and discharging state parameters of the n-th type of the energy storage device.

$${P}_{E S , t}^{n}$$

is the output power of the n-th type of the energy storage device in the “t” period,

$${η}_{E S}^{c h a , n} and {η}_{E S}^{d i s , n}$$

are respectively the charging and discharging efficiencies of the n-th type of the energy storage device in the “t” period, and S_{n,t} is the capacity of the n-th type of the energy storage device in the “t” period.

Step 2: building the electro-thermal load demand coordination response model by considering peak-valley complementary characteristics of the original electric and thermal load in the system, wherein characterizing the electric load by the time-of-use price demand response method, by considering the thermal load has heat transfer inertia and fuzziness of user temperature perception, adjusting the electro-thermal load demand flexibly based on the different electricity prices.

### Step 2.1 Modeling of Electrical Load Demand Response Model

In the present invention, a time-of-use electricity price demand response method is used as a representative to carry out an electricity load demand response study, and because different types of loads have different sensitivities to the same electricity price signal, the electricity load is divided into a curtailable load, a transferable load and a substitutional load. Contract management mode is adopted for electric load, and contracts are signed between energy suppliers and users. The user informs the energy supplier of the various flexible load powers in each time period in advance, and negotiates the compensation prices and allowable interaction time periods for various loads; the energy supplier flexibly adjusts the user's demand for flexible load energy in different time periods according to its own supply capacity, and compensates the user according to the size of the user's participation in the interaction power, as follows:

### Step 2.1.1 Curtailable Load

During a price peak period, reducing the use of certain unused loads to reduce the user's own energy costs. Demand response characteristics are described by a price-demand elasticity matrix, i.e., an elasticity coefficient of load at time t to price at time j. The formula is as follows:

$$\{ \begin{matrix}{σ}_{t , t} = \frac{Δ {P}_{L , t}^{e}}{{P}_{L , t}^{e 0}} \frac{{q}_{t}^{e 0}}{Δ {q}_{t}^{e}} \\ {σ}_{t , j} = \frac{Δ {P}_{L , t}^{e}}{{P}_{L , t}^{e 0}} \frac{{q}_{j}^{e 0}}{Δ {q}_{j}^{e}}\end{matrix} \qquad ( 9 )$$

wherein, σ_{t,t} is the self-elastic coefficient, σ_{t,j} is the cross-elastic coefficient;

$${P}_{L , t}^{e 0}$$

is that initial load demand of the user at the time t, ΔP_{L,t}^{e} is the load variation amount of the user at the time t,

$${q}_{t}^{e 0} and {q}_{j}^{e 0}$$

represent the initial value of the electricity price at the time t and the time j, =

$$Δ {q}_{t}^{e} and Δ {q}_{j}^{e}$$

represent the electricity price variation amount at the time t and the time j, respectively. After demand response adjustment, the variation of load reduction at the time t is as follows:

$$Δ {P}_{CL , t}^{e} = {P}_{CL , t}^{e 0} [ {\sum }_{j = 1}^{24} {σ}_{CL} ( t , j ) \frac{{q}_{j}^{e} - {q}_{j}^{e 0}}{{q}_{j}^{e 0}} ] \qquad ( 10 )$$

wherein,

$$Δ {P}_{CL , t}^{e}$$

is the initial load reduction amount at the time t,

$${P}_{CL , t}^{e 0}$$

is the curtailable load demand at the time t, σ_{CL}(t, j) is the curtailable load demand matrix coefficient of the demand matrix, and

$${q}_{j}^{e}$$

is the electricity price at the time j.

According to the signed contract, the user will receive corresponding economic compensation, and the formula is as follows:

$${C}_{CL} = {C}_{CL , p} Δ {P}_{CL , t}^{e} \qquad ( 11 )$$

wherein, C_{CL,p} is the compensation price per unit of allowable load reduction.

### Step 2.1.2 Transferable Load

On the basis of keeping the total load power unchanged, the electricity price is used as the signal to shift on the time scale, and the flexible adjustment of working time is realized. The present invention uses a price demand elasticity matrix to describe demand response characteristics, and the amount of change of the transferable load at the time t after demand response processing is shown as follows:

$$Δ {P}_{TL , t}^{e} = {P}_{TL , t}^{e 0} [ {\sum }_{j = 1}^{24} {σ}_{TL} ( t , j ) \frac{{q}_{j}^{e} - {q}_{j}^{e 0}}{{q}_{j}^{e 0}} ] \qquad ( 12 )$$

wherein, ΔP_{TL,t}^{e} is the initial transferable load at the time t and σ_{TL}(t, j) is the price elasticity coefficient of the transferable load of the demand matrix.

According to the signed contract, the user will receive corresponding economic compensation, and the formula is as follows:

$${C}_{TL} = {C}_{TL , p} Δ {P}_{TL , t}^{e} \qquad ( 13 )$$

wherein, C_{TL,p} is the compensation price of the transferable load of per unit.

### Step 2.1.3 Substitutional Load

The substitutional load is defined as a type of heat load that can be supplied directly by heat or electricity, which is supplied by electricity at low electricity prices and directly by heat at high electricity prices. The formula is as follows:

$$Δ {P}_{SL , t}^{e} = - {ε}_{e , h} Δ {P}_{SL , t}^{h} \qquad ( 14 )$$

$${ε}_{e , h} = \frac{{v}_{e} {φ}_{e}}{{v}_{h} {φ}_{h}} \qquad ( 15 )$$

wherein,

$$Δ {P}_{SL , t}^{e}$$

is the substitutional electric load,

$$Δ {P}_{SL , t}^{h}$$

is the heat load to be substituted, ε_{e,h} is the electro-thermal substitution coefficient, vₑ is the unit calorific value of electric energy, Vₕ is the unit calorific value of thermal energy, φₑ is the energy utilization rate of electric energy, φₕ is the energy utilization rate of thermal energy, and “-” indicates that the electric load in the alternative load is decreasing and the thermal load is increasing.

According to the signed contract, the user will receive corresponding economic compensation, the formula is as follows:

$${C}_{SL} = {C}_{SL , p} Δ {P}_{SL , t}^{e} \qquad ( 16 )$$

wherein, C_{SL,p} is the compensation price of the substitutional load of per unit.

In summary, the electrical load at the time t consists of the following three components:

$${P}_{L , t}^{e} = {P}_{L , t}^{e 0} + Δ {P}_{C L , t}^{e} + Δ {P}_{T L , t}^{e} + Δ {P}_{S L , t}^{e} \qquad ( 17 )$$

wherein,

$${P}_{L , t}^{e 0} and {P}_{L , t}^{e}$$

are the electrical load powers at the time t before and after the demand response, respectively.

### Step 2.2 Modeling of Heat Load Demand Response Model

The thermal load has two characteristics: inertia of heat transfer and fuzziness of user temperature perception, which together constitute flexibility of thermal load. Because of the thermal inertia of the thermal system, changes in the amount of heat supplied do not immediately change the user's perception. Due to the fuzzy and hysteresis of user perception of temperature, the temperature can be controlled within a comfortable range to further improve the economy of the integrated energy system.

### Step 2.2.1 Thermal Load Inertia Characteristic

Considering the thermal load has heat transfer inertia and fuzziness of user temperature perception, flexible adjustment is made based on different electricity prices, including: analyzing the thermodynamic characteristics of heating buildings and heating networks according to the inertia of heat transfer of thermal load, obtaining the dynamic relationship between heat output of cogeneration and building room temperature, and describing the temperature dynamics of heating system by using autoregressive moving average model, i.e., the flow and pressure of heating networks remain unchanged, and only the temperature is adjusted. The formula is as follows:

$${T}_{h , t} = {\sum }_{j = 1}^{J} {α}_{j} {T}_{h , t - j} + {\sum }_{j = 0}^{J} {β}_{j} {T}_{g , t - j} + {\sum }_{j = 0}^{J} {γ}_{j} {T}_{o u t , t - j} \qquad ( 18 )$$

$${T}_{i n , t} = {θ}_{1} {T}_{i n , t - 1} + {φ}_{1} {T}_{g , t - 1} + {ω}_{1} {T}_{o u t , t - 1} \qquad ( 19 )$$

wherein, T_{in,t} is the indoor temperature of the building at the time t; αⱼ, βⱼ, γⱼ, θ₁, φ₁ and ω₁ are physical parameters of the thermal inertia of the heating system, which can be obtained by parameter identification of the measured data. t-j is a time period delayed by j units. J is the order of the autoregressive moving average time series model, representing the delay of the heat transfer process and reflecting the thermal inertia of the heating system. T_{h,t-j}, T_{g,t-j} and T_{out,t-j} are the return water temperature, supply water temperature and ambient temperature at the time t-j, respectively, and, T_{in,t-1}, T_{g,t-1} and T_{out,t-1} are the indoor temperature of the building, supply water temperature and ambient temperature at time t−1, respectively.

The relationship between the indoor temperature and the thermal load power can be expressed as:

$${T}_{i n , t + 1} = {T}_{i n , t} {e}^{- Δ t / τ} + ( R {P}_{L , t}^{h} + {T}_{o u t , t} ) ( 1 - {e}^{- Δ t / τ} ) \qquad ( 20 )$$

$$τ = R \cdot {C}_{a i r} \qquad ( 21 )$$

wherein, e is the natural base, Cₐᵢᵣ is the indoor heat capacity of the building, R is the equivalent thermal resistance of the building (° C./MW),

$${P}_{L , t}^{h}$$

is the thermal load power at the time t, and Δt is the minimum dispatch period. When the indoor temperature fluctuates in a certain interval, the space heat load is also an interval.

Based on the Equation (20), the thermal load power relationship based on indoor air temperature is calculated as:

$${P}_{L , t}^{h} = \frac{1}{R} ( \frac{{T}_{i n , t + 1} - {T}_{in , t} {e}^{- Δ t / τ}}{1 - {e}^{- Δ t / τ}} - {T}_{o u t , t} ) \qquad ( 22 )$$

### Step 2.2.2 Fuzziness of User Temperature Perception

Because users have certain fuzziness to heating comfort, when the heating temperature changes within the range of human comfort, the impact on users is small, and the adjustment ability of flexible load is improved to a certain extent. Therefore, the predicted thermal index (predicted average voting index, PAVI) is used in the present invention as a criterion for evaluating thermal comfort of indoor environment. The relationship between the index and temperature is as follows:

$${λ}_{PMV} = \{ \begin{matrix}0.3895 ( {T}_{in , t} - 26 ) , {T}_{in , t} \geq 26 \\ 0.4065 ( 26 - {T}_{in , t} ) , {T}_{in , t} < 26\end{matrix} \qquad ( 23 )$$

wherein, λ_{PMV} is the value of the PAVI.

The relationship between the PAVI and the temperature in the present invention can be divided into seven grades, as shown in Table 1 below:

TABLE 1
Relationship between PAVI and temperature

| Cold/hot | | Relatively | Slightly | | Slightly | Relatively | |
|---|---|---|---|---|---|---|---|
| somatosensory | Hot | hot | hot | Comfort | cold | cold | Cold |
| PAVI | 3 | 2 | 1 | 0 | −1 | −2 | −3 |

As shown in Equation (22), there is a time-coupling relationship between the thermal power of the thermal load and its indoor temperature. When the indoor temperature is allowed to fluctuate within a comfort range, the thermal power has certain elasticity. By setting the range of the PAVI, based on Table 1, the minimum indoor temperature

$${T}_{in , t}^{lb}$$

and the maximum indoor temperature

$${T}_{in , t}^{ub}$$

of the heat load can be obtained from Equation (23). According to the Equation (22), minimum heating power

$${P}_{lb , t}^{h}$$

and maximum heating power

$${P}_{u b , t}^{h}$$

of the system thermal load in the whole dispatching period can be obtained.

### Step 2.3 Building Electro-Thermal Load Demand Coordination Response Model

Obtaining the heat balance relationship without considering the flexibility of heat load, and based on the analysis of electro-thermal load demand coordination response strategy, obtaining a coordination mode of electrical and thermal power demand response under peaking demand, including a low load period, a peak load period, and an average load period.

Regardless of the flexibility of the thermal load, the heat balance equation is as follows:

$${P}_{s , t}^{h} = {P}_{GB , t}^{h} + {P}_{CHP , t}^{h} + {P}_{ES , t}^{h , dis} - {P}_{ES , t}^{h , char} = {P}_{s t , t}^{h} \qquad ( 24 )$$

wherein,

$${P}_{s , t}^{h}$$

is the actual power of the thermal load at the time t, and

$${P}_{s t , t}^{h}$$

is the standard power at the time t without considering the inertia of the thermal load.

$${P}_{CHP , t}^{h} and {P}_{GB , t}^{h}$$

are the heating powers of the CHP and the gas-fired boiler at the time t respectively;

$${P}_{ES , t}^{h , dis} and {P}_{ES , t}^{h , char}$$

are the heat release power and heat storage power of the heat storage device at the time t respectively.

Considering the flexibility of the heat load, the system firstly allows the heat load to vary between the minimum heating power and the maximum heating power, and then determines the most suitable heating power within the heating power range according to the peak demand. The formula is as follows:

$${P}_{lb , t}^{h} \leq {P}_{s , t}^{h} \leq {P}_{ub , t}^{h} \qquad ( 25 )$$

According to the analysis of the electro-thermal load demand coordination response strategy, the coordinated mode of power and thermal demand response under peak load can be summarized. The details are as follows:

(1) In the low load period, the heating power may be reasonably optimized between the standard heating power and the minimum heating power. The formula is as follows:

$${P}_{lb , t}^{h} \leq {P}_{s , t}^{h} \leq {P}_{st , t}^{h} \qquad ( 26 )$$

wherein,

$${P}_{s , t}^{h}$$

is the actual power of the thermal load at the time t,

$${P}_{st , t}^{h} and {P}_{lb , t}^{h}$$

are the standard heating power and the minimum heating power of the thermal load at the time t, respectively.

(2) During the peak load period, the heating power should be reasonably optimized between the standard heating power and the maximum heating power. The formula is as follows:

$${P}_{st , t}^{h} \leq {P}_{s , t}^{h} \leq {P}_{ub , t}^{h} \qquad ( 27 )$$

wherein, P_{s,t}^{h} is the actual power of the thermal load at the time t,

$${P}_{st , t}^{h} and {P}_{ub , t}^{h}$$

are the standard heating power and the maximum heating power of the thermal load at the time t.

(3) During the average load period, the heating power can be reasonably optimized between the minimum and maximum heating powers, and connected with the peak and valley heating powers.

$${P}_{lb , t}^{h} \leq {P}_{s , t}^{h} \leq {P}_{ub , t}^{h} \qquad ( 28 )$$

wherein,

$${P}_{s , t}^{h}$$

is the actual power of the heat load at the time t,

$${P}_{lb , t}^{h} and {P}_{ub , t}^{h}$$

are the minimum and maximum heating powers of the heat load at the time t.

Step 3: based on the hydrogen-containing microgrid operation model and the electro-thermal load demand coordination response model, building the objective function with the objective of minimizing the sum of the total operation cost of the microgrid in the future, the wind and light curtailed cost of the renewable energy and the demand response compensation cost.

In order to maximize the operating benefit of the electro-hydrogen coupling microgrid and meet the energy demand of electric energy, hydrogen energy, gas energy and heat energy, it is necessary to coordinate the operating strategies of various devices. Based on the hydrogen-containing microgrid operation model and the electro-thermal load demand coordination response model built above, the present invention proposes an electro-hydrogen coupling microgrid optimization scheduling strategy taking the minimum sum of the total operation cost of the microgrid in the future, the wind and light curtailed cost of the renewable energy and the demand response compensation cost as the objective function, and builds a mixed integer linear programming model to realize multi-energy complementarity within the microgrid.

### Step 3.1 Objective Function

### Step 3.1.1 Total Cost of Microgrid Operation

Economy is the most important consideration in microgrid planning and design.

Therefore, one of the main objectives of the optimization scheduling strategy is to minimize the total cost of operation, as follows:

$${F}_{1} = {C}_{init} + {C}_{om} + {C}_{water} + {C}_{hydro} + {C}_{grid} \qquad ( 29 )$$

wherein, Cᵢₙᵢₜ and Cₒₘ are the acquisition cost and operation-maintenance cost of main equipment respectively; C_{water}, C_{hydro} and C_{grid} are the cost of hydrogen production water, hydrogen purchase cost and transaction cost with external power and gas grids respectively.

### (1) Cost of Equipment

The acquisition cost Cᵢₙᵢₜ refers to the total initial investment cost of the major equipment of the microgrid company. In order to comprehensively consider the impact of equipment life on microgrid, the acquisition cost is converted into an annualized equivalent investment amount. The formula is as follows:

$${C}_{init} = ( {\sum }_{j ∈ ℝ} {c}^{j , init} \cdot {N}^{j} ) \cdot σ \qquad ( 30 )$$

$$σ = \frac{r \cdot {( 1 + c )}^{Y}}{{( 1 + r )}^{Y} - 1} \qquad ( 31 )$$

wherein, [symbol] is the collection of the photovoltaic generator unit, electrolytic cell model and other equipment, c^{j,init} is the acquisition cost of the equipment j, N^{j} is the purchased number of the equipment j, σ is the capital recovery coefficient, r is the benchmark interest rate, and Y is the service life of the microgrid.

### (2) Operation-Maintenance Cost

The operation-maintenance cost Cₒₘ refers to the annual operation and maintenance cost of major equipment in the microgrid. The annual operation and maintenance cost of each equipment is directly proportional to its acquisition cost. The formula is as follows:

$${C}_{om} = {\sum }_{j ∈ R} {c}^{j , om} \cdot {N}^{j} \qquad ( 32 )$$

wherein, c^{j,om} is the acquisition cost of the equipment j.

### (3) Cost of Hydrogen Production Water

The electrolysis of water to produce hydrogen requires water consumption, and the water consumption is related to the specific amount of hydrogen production. Including the cost of using water C_{water} in the total cost, and the formula is as follows:

$${C}_{water} = {V}_{water} \cdot {c}^{water} \qquad ( 33 )$$

wherein, V_{water} is the water consumption for hydrogen production; c^{water} is the unit price of water used in the electrolysis process.

### (4) Hydrogen Purchase Cost

When the hydrogen produced by electrolysis cannot meet the system demand, it is necessary to purchase hydrogen from outside. The formula for hydrogen purchase cost C_{hydro} is as follows:

$${C}_{hydro} = {W}_{hydro} \cdot {c}^{hydro} \qquad ( 34 )$$

wherein, W_{hydro} is the total weight of hydrogen purchased; c^{hydro} is the unit cost of the hydrogen purchased.
   (5) Transaction Cost with External Power and Gas Grids

When the microgrid is connected to an external power grid or gas grid, when there is excess electricity or natural gas, the remaining energy can be sold to the external power grid or gas grid. Conversely, when the microgrid lacks sufficient energy, electricity and natural gas can be purchased from external power grids and gas grids. Transaction costs with external electrical networks are determined by the cost of purchasing scarce electricity and gas from the external grid and the revenue from selling excess electricity and gas to the external grid, and the formula is as follows:

$${C}_{grid} = {\sum }_{t ∈ T} ( {c}_{t}^{grid} \cdot {P}_{t}^{grid} ) \qquad ( 35 )$$

wherein, T is the evaluation time of microgrid operation,

$${c}_{t}^{grid}$$

is the purchase price, and

$${P}_{t}^{grid}$$

is the purchase/sale of electricity or natural gas. When external electric and gas grids are supplied,

$${P}_{t}^{grid} = 0 ;$$

when sold to external grids,

$${P}_{t}^{grid} < 0 .$$

### Step 3.1.2 Wind and Light Curtailed Costs of Renewable Energy

When the power generation capacity of the renewable energy unit of the microgrid exceeds the power demand at the time t, the phenomenon of power curtailment will occur, resulting in waste. Therefore, the present invention fully considers the situation of wind and light curtailment of new energy, and the calculation formula is shown as follows:

$${F}_{2} = \frac{{E}_{curt}}{{E}_{GE}} \qquad ( 36 )$$

wherein, F₂ is the cost of wind and light curtailment of the renewable energy of the microgrid, E_{curt} is the total amount of electricity intercepted by the microgrid, and E_{GE} is the sum of wind and solar power generation.

### Step 3.1.3 Power Demand Response Compensation Cost

The calculation of the demand response cost is based on providing compensation for user participation in demand response by shifting load to compensate users. Compensation cost is expressed as follows:

$${F}_{3} = {C}_{CL} + {C}_{TL} + {C}_{SL} \qquad ( 37 )$$

wherein, F₃ is the power demand response compensation cost for the microgrid, and C_{CL}, C_{TL}, C_{SL} are the compensation prices for curtailable load, transferable load, and replaceable load, respectively.

### Step 3.2 Constraints

In order to ensure the safe and stable operation of the microgrid, the following constraints need to be met.

### Step 3.2.1 Renewable New Energy Generator Unit Output Constraint

The wind power generation unit and photovoltaic power generation unit need to meet the following constraints:

$$\{ \begin{matrix}0 \leq {P}_{PV , t} \leq {P}_{PV}^{max} \\ 0 \leq {P}_{WT , t} \leq {P}_{WT}^{max}\end{matrix} \qquad ( 38 )$$

### Step 3.2.2 Electro-hydrogen Coupling Unit Operation Constraints

### (1) Electrolytic Cell Model

The following constraints need to be satisfied for proper operation of the electrolytic cell model:

$$\{ \begin{matrix}{P}_{EL}^{min , e} \leq {P}_{EL , t}^{e} \leq {P}_{EL}^{max , e} \\ Δ {P}_{EL}^{min , e} \leq {P}_{EL , ( t + 1 )}^{e} - {P}_{EL , t}^{e} \leq Δ {P}_{EL}^{max , e}\end{matrix} \qquad ( 39 )$$

wherein,

$${P}_{EL}^{max , e} and {P}_{EL}^{min , e}$$

are the upper and lower limits of the electrical power input to the electrolytic cell model respectively;

$$Δ {P}_{EL}^{max , e} and Δ {P}_{EL}^{min , e}$$

are the upper and lower limits of the ramp rate of the electrolytic cell model respectively.

### (2) Methane Reactor Model

The methane reactor model needs to satisfy the following constraints for proper operation:

$$\{ \begin{matrix}{P}_{MR}^{min , {H}_{2}} \leq {P}_{MR , t}^{{H}_{2}} \leq {P}_{MR}^{max , {H}_{2}} \\ Δ {P}_{MR}^{min , {H}_{2}} \leq {P}_{MR , ( t + 1 )}^{{H}_{2}} - {P}_{MR , t}^{{H}_{2}} \leq Δ {P}_{MR}^{max , {H}_{2}}\end{matrix} \qquad ( 40 )$$

wherein,

$${P}_{MR}^{max , {H}_{2}} and {P}_{MR}^{min , {H}_{2}}$$

are the upper and lower limits of the electrical power input to the methane reactor model respectively;

$$Δ {P}_{MR}^{max , {H}_{2}} and Δ {P}_{MR}^{min , {H}_{2}}$$

are the upper and lower limits of the ramp rate of the methane reactor model respectively.

### (3) Hydrogen Fuel Cell Model

The hydrogen fuel cell model needs to satisfy the following constraints for proper operation:

$$\{ \begin{matrix}{P}_{HFC}^{min , {H}_{2}} \leq {P}_{HFC , t}^{{H}_{2}} \leq {P}_{HFC}^{max , {H}_{2}} \\ Δ {P}_{HFC}^{min , {H}_{2}} \leq {P}_{HFC , ( t + 1 )}^{{H}_{2}} - {P}_{HFC , t}^{{H}_{2}} \leq Δ {P}_{HFC}^{max , {H}_{2}} \\ {κ}_{HFC}^{min} \leq {P}_{HFC , t}^{h} / {P}_{HFC , t}^{e} \leq {κ}_{HFC}^{max}\end{matrix} \qquad ( 41 )$$

wherein,

$${P}_{HFC}^{max , {H}_{2}} and {P}_{HFC}^{min , {H}_{2}}$$

are the upper and lower limits of hydrogen power input to the hydrogen fuel cell,

$$Δ {P}_{HFC}^{max , {H}_{2}} and Δ {P}_{HFC}^{min , {H}_{2}}$$

are the upper and lower limits of the ramp rate of the hydrogen fuel cell, and

$${κ}_{HFC}^{max} and {κ}_{HFC}^{min}$$

are the upper and lower limits of thermoelectric ratio of the hydrogen fuel cell.

### Step 3.2.3 Heat Generation Unit Operation Constraint

### (1) CHP Unit

The CHP unit needs to satisfy the following constraints for proper operation:

$$\{ \begin{matrix}{P}_{CHP}^{min , g} \leq {P}_{CHP , t}^{g} \leq {P}_{CHP}^{max , g} \\ Δ {P}_{CHP}^{min , g} \leq {P}_{CHP , ( t + 1 )}^{g} - {P}_{CHP , t}^{g} \leq Δ {P}_{CHP}^{max , g} \\ {κ}_{CHP}^{min} \leq {P}_{CHP , t}^{h} / {P}_{CHP , t}^{e} \leq {κ}_{CHP}^{max}\end{matrix} \qquad ( 42 )$$

wherein,

$${P}_{CHP}^{max , g} and {P}_{CHP}^{min , g}$$

are the upper and lower limits of natural gas power input to the CHP unit,

$$Δ {P}_{CHP}^{max , g} and Δ {P}_{CHP}^{min , g}$$

are the upper and lower limits of the ramp rate of the CHP unit, and κ_{CHP}^{max} and κ_{CHP}^{min} are the upper and lower limits of the thermoelectric ratio of the hydrogen fuel cell.

### (2) Gas-fired Boiler Unit

The gas-fired boiler model needs to satisfy the following constraints for proper operation:

$$\{ \begin{matrix}{P}_{GB}^{min , g} \leq {P}_{GB , t}^{g} \leq {P}_{GB}^{max , g} \\ Δ {P}_{GB}^{min , g} \leq {P}_{GB , ( t + 1 )}^{g} - {P}_{GB , t}^{g} \leq Δ {P}_{GB}^{max , g}\end{matrix} \qquad ( 43 )$$

wherein,

$${P}_{GB}^{max , g} and {P}_{GB}^{min , g}$$

are the upper and lower limits of natural gas power input to the gas-fired boiler unit respectively, and

$$Δ {P}_{GB}^{max , g} and Δ {P}_{GB}^{min , g}$$

are the upper and lower limits of the ramp rate of the gas-fired boiler unit respectively.

### Step 3.2.4 Storage Operating Constraint

Because the models of electricity, heat and gas storage equipment are similar, the unified modeling of the electricity, heat, gas and hydrogen storage equipment is carried out.

$$\{ \begin{matrix}0 \leq {P}_{ES , t}^{cha , n} \leq {B}_{ES , t}^{cha , n} {P}_{ES}^{max , n} \\ 0 \leq {P}_{ES , t}^{dis , n} \leq {B}_{ES , t}^{dis , n} {P}_{ES}^{max , n} \\ {S}_{n}^{min} \leq {S}_{n , t} \leq {S}_{n}^{max}\end{matrix} \qquad ( 44 )$$

wherein,

$${P}_{ES}^{max , n}$$

is the maximum power of single charge and discharge of the n-th type of the energy storage device,

$${S}_{n}^{max} and {S}_{n}^{min}$$

are the upper and lower limits of the capacity of the n-th type of the energy storage device respectively.

### Step 3.2.5 Electrical Power Balancing

$$( 45 )$$

$${P}_{buy , t}^{e} + {P}_{PV , t}^{e} + {P}_{WT , t}^{e} + {P}_{HFC , t}^{e} + {P}_{CHP , t}^{e} = {P}_{t}^{e \_ Load} + {P}_{sell , t}^{e} + {P}_{EL , t}^{e} + {P}_{ES , t}^{e}$$

wherein,

$${P}_{t}^{e \_ Load}$$

is the electrical load during the t period,

$${P}_{buy , t}^{e} and {P}_{sell , t}^{e}$$

are the purchased and sold electrical power during each period, respectively, and

$${P}_{EL , t}^{e}$$

is the power input to the electrical storage during the t period.

### Step 3.2.6 Thermal Power Balancing

$${P}_{HFC , t}^{h} + {P}_{CHP , t}^{h} + {P}_{GB , t}^{h} = {P}_{t}^{h\_Load} + {P}_{E S , t}^{h} \qquad ( 46 )$$

wherein,

$${P}_{t}^{h\_Load}$$

is the heat load during the t period, and P_{ES,t}^{h} is the input power to the thermal storage during the t period.

### Step 3.2.7 Natural Gas Balancing

$${P}_{M R , t}^{g} + {P}_{buy , t}^{g} = {P}_{s e l l , t}^{g} + {P}_{CHP , t}^{g} + {P}_{G B , t}^{g} + {P}_{E S , t}^{g} \qquad ( 47 )$$

wherein,

$${P}_{b u y , t}^{g} and {P}_{s e l l , t}^{g}$$

are the natural gas purchased and sold in each period, respectively, and

$${P}_{E S , t}^{g}$$

is the power input to the gas reservoir during the t period.

### Step 3.2.8 Hydrogen Balancing

$${P}_{EL , t}^{{H}_{2}} + {P}_{buy , t}^{{H}_{2}} = {P}_{MR , t}^{{H}_{2}} + {P}_{HFC , t}^{{H}_{2}} + {P}_{s e l l , t}^{{H}_{2}} + {P}_{ES , t}^{{H}_{2}} \qquad ( 48 )$$

wherein,

$${P}_{buy , t}^{{H}_{2}} and {P}_{s e l l , t}^{{H}_{2}}$$

are hydrogen purchased and sold in each period, respectively, and

$${P}_{ES , t}^{{H}_{2}}$$

is the power input to hydrogen storage during the t period.

### Step 3.2.9 Model Linearization Treatment

The economic dispatch model of hydrogen-containing microgrid considering the electro-thermal load demand coordination response is a mixed integer nonlinear model, so it needs to be transformed into a mixed integer linear programming problem by piecewise linearization, and then solved by a commercial solver-CPLEX.

According to the solution result, the control instructions for optimizing the operation of each unit equipment in the electro-hydrogen coupling microgrid in the future are generated, and sent to the each unit equipment and corresponding regulation equipment in the electro-hydrogen coupling microgrid, to control the each unit equipment and corresponding regulation equipment to perform operation output according to the optimal operation scheduling strategy, so as to realize the coupling microgrid optimization scheduling considering the electro-thermal load demand coordination response.

### Example 2

The present example of the invention provides an optimization scheduling system for a coupling microgrid considering electro-thermal load demand coordination, comprising:
a model building module, for building a hydrogen-containing microgrid operation model based on operation characteristics and interaction of new energy generating units, electro-hydrogen coupling units, heat generating units and energy storage units; and, building an electro-thermal load demand coordination response model by considering peak-valley complementary characteristics of an original electric load and a thermal load in system;
a demand coordination response optimization module, for characterizing an electric load by a time-of-use price demand response method, by considering a thermal load has heat transfer inertia and fuzziness of user temperature perception, adjusting electro-thermal load demand flexibly based on different electricity prices; and
an operation scheduling module, for based on the hydrogen-containing microgrid operation model and the electro-thermal load demand coordination response model, building an objective function with an objective of minimizing a sum of a total operation cost of a microgrid in the future, a wind and light curtailed cost of renewable energy and a demand response compensation cost, building an electro-hydrogen coupling microgrid optimal scheduling model according to constraint conditions, then solving the electro-hydrogen coupling microgrid optimal scheduling model by a MILP, generating control instructions for optimizing operations of each unit equipment in an electro-hydrogen coupling microgrid in the future and sending the control instructions to the each unit equipment and corresponding regulation equipment in the electro-hydrogen coupling microgrid, and controlling the each unit equipment and the corresponding regulation equipment to perform operation and output according to an optimal operation scheduling strategy in the control instructions, so as to realize the optimization scheduling of the coupling microgrid considering the electro-thermal load demand coordination.

### Example 3

The present example of the invention provides a non-transitory computer-readable storage medium, having computer instructions stored thereon, wherein when the computer instructions are executed by a processor, causing the processor to implement the optimization scheduling method for the coupling microgrid considering electro-thermal load demand coordination according to Example 1.

### Example 4

The present example of the invention provides an electronic equipment, comprising a processor, a memory and a computer program, wherein the processor is connecting to the memory, the computer program is stored in the memory, and when the electronic equipment runs, the processor executes the computer program stored in the memory, causing the electronic equipment to execute the optimization scheduling method for the coupling microgrid considering electro-thermal load demand coordination according to Example 1.

The present invention is described with reference to flowcharts and/or block diagrams of methods, devices (systems), and computer program products according to the examples of the present invention. It should be understood that each of the processes and/or boxes in the flowchart and/or block diagram, and the combination of the processes and/or boxes in the flowchart and/or block diagram, may be implemented by computer program instructions. These computer program instructions may be provided to a processor of a general purpose computer, a specialized computer, an embedded processor, or other programmable data processing device to produce a machine such that the instructions executed by the processor of the computer or other programmable data processing device produce a device for implementing the functions specified in one process or multiple processes of the flowchart and/or one box or multiple boxes of the block diagram.

These computer program instructions may also be stored in a computer-readable memory capable of directing the computer or other programmable data processing apparatus to operate in a particular manner such that the instructions stored in such the computer-readable memory produce an article of manufacture comprising an instruction device that implements the function specified in one process or a plurality of processes of the flowchart and/or one box or a plurality of boxes of the block diagram.

Although the specific embodiments of the present invention are described above in combination with the accompanying drawings, it is not a limitation on the protection scope of the present invention. Those skilled in the art should understand that on the basis of the technical scheme of the present invention, various modifications or deformations that can be made by those skilled in the art without creative labor are still within the protection scope of the present invention.

1. An optimization scheduling method for a coupling microgrid considering electro-thermal load demand coordination, comprising:
building a hydrogen-containing microgrid operation model based on operation characteristics and interaction of new energy generating units, electro-hydrogen coupling units, heat generating units and energy storage units; wherein
the hydrogen-containing microgrid operation model comprise a distributed new energy generating unit model, an electro-hydrogen couple unit model, a heat generating unit model and an energy storage model, wherein the distributed new energy generating unit model comprise a wind power generator unit and a photovoltaic generating unit; the electro-hydrogen coupling unit model comprises the electrolytic cell model, the methane reactor model and the hydrogen fuel cell model; the heat generating unit model comprises the combined heat and power (CHP) unit and a gas-fired boiler model; and, the energy storage model is a unified modeling of four energy devices: electricity, heat, gas, and hydrogen;
building an electro-thermal load demand coordination response model by considering peak-valley complementary characteristics of an original electric load and a thermal load in system, characterizing an electric load by a time-of-use electricity price demand response method, by considering a thermal load has heat transfer inertia and fuzziness of user temperature perception, adjusting electro-thermal load demand flexibly based on different electricity prices;
wherein
building the electro-thermal load demand coordination response model, characterizing the electric load by using the time-of-use electricity price demand response method, comprises:
carrying out an electricity load demand response study by using the time-of-use electricity price demand response method, dividing the electricity load into a curtailable load, a transferable load and a substitutional load; using a contract management mode for the electric load, wherein signing contracts between energy suppliers and users, the user informs the energy supplier of various flexible load powers in each time period in advance, and negotiates compensation prices and allowable interaction time periods for various loads; the energy suppliers flexibly adjust the users' demand for flexible load energy in different time periods according to own supply capacity of the energy suppliers, and compensates the users according to a size of a user's participation in an interaction power;
the electro-thermal load demand coordination response model comprises:
obtaining the heat balance relationship without considering the flexibility of heat load, and based on the analysis of electro-thermal load demand coordination response strategy, obtaining a coordination mode of electrical and thermal power demand response under peaking demand, including a low load period, a peak load period, and an average load period;
regardless of the flexibility of the thermal load, the heat balance equation is as follows:
$${P}_{s , t}^{h} = {P}_{G B , t}^{h} + {P}_{CHP , t}^{h} + {P}_{ES , t}^{h , d i s} - {P}_{ES , t}^{h , c h a r} = {P}_{s t , t}^{h} ;$$
wherein,
$${P}_{s , t}^{h}$$
is an actual power of the thermal load at the time t, and
$${P}_{s t , t}^{h}$$
is a standard power at the time t without considering the inertia of the thermal load.
$${P}_{CHP , t}^{h} and {P}_{G B , t}^{h}$$
are heating powers of the CHP and the gas-fired boiler at the time t respectively;
$${P}_{ES , t}^{h , d i s} and {P}_{ES , t}^{h , c h a r}$$
are heat release power and heat storage power of the heat storage device at the time t respectively;
considering the flexibility of the heat load, the system firstly allows the heat load to vary between minimum heating power and maximum heating power, and then determines heating power within the heating power range according to peak demand; a formula is as follows:
$${P}_{l b , t}^{h} \leq {P}_{s , t}^{h} \leq {P}_{u b , t}^{h} ;$$
according to the analysis of the electro-thermal load demand coordination response strategy, coordinated mode of power and thermal demand response under peak load can be summarized, and details are as follows:
(1) in the low load period, heating power may be optimized between standard heating power and minimum heating power; a formula is as follows:
$${P}_{l b , t}^{h} \leq {P}_{s , t}^{h} \leq {P}_{s t , t}^{h} ;$$
wherein,
$${P}_{s , t}^{h}$$
is an actual power of the thermal load at a time t,
$${P}_{st , t}^{h} and {P}_{lb , t}^{h}$$
are standard heating power and minimum heating power of the thermal load at the time t, respectively;
(2) during the peak load period, heating power may be optimized between standard heating power and maximum heating power; a formula is as follows:
$${P}_{st , t}^{h} \leq {P}_{s , t}^{h} \leq {P}_{ub , t}^{h} ;$$
wherein,
$${P}_{s , t}^{h}$$
is an actual power of the thermal load at the time t,
$${P}_{st , t}^{h} and {P}_{ub , t}^{h}$$
are standard heating power and maximum heating power of the thermal load at the time t;
(3) during the average load period, heating power may be optimized between the minimum and maximum heating powers, and connected with the peak and valley heating powers;
$${P}_{lb , t}^{h} \leq {P}_{s , t}^{h} \leq {P}_{ub , t}^{h} ;$$
wherein,
$${P}_{s , t}^{h}$$
is an actual power of the heat load at the time t,
$${P}_{lb , t}^{h} and {P}_{ub , t}^{h}$$
are minimum and maximum heating powers of the heat load at the time t;
and,
based on the hydrogen-containing microgrid operation model and the electro-thermal load demand coordination response model, building an objective function with an objective of minimizing a sum of a total operation cost, a wind and light curtailed cost of renewable energy and a demand response compensation cost, building an electro-hydrogen coupling microgrid optimal scheduling model according to constraint conditions, then solving the electro-hydrogen coupling microgrid optimal scheduling mode by a mixed integer linear programming (MILP), and applying a solved optimal operation scheduling strategy of equipment to the microgrid for executing.

2. The optimization scheduling method for the coupling microgrid considering electro-thermal load demand coordination according to claim 1, wherein considering the thermal load has heat transfer inertia and fuzziness of user temperature perception, flexible adjustment is made based on different electricity prices, comprising: analyzing the thermodynamic characteristics of heating buildings and heating networks according to the inertia of heat transfer of thermal load, obtaining the dynamic relationship between heat output of cogeneration and building room temperature, and describing the temperature dynamics of heating system by using autoregressive moving average model, comprises the flow and pressure of heating networks remain unchanged, and only the temperature is adjusted.

3. The optimization scheduling method for the coupling microgrid considering electro-thermal load demand coordination according to claim 1, wherein considering the thermal load has heat transfer inertia and fuzziness of user temperature perception, flexible adjustment is made based on different electricity prices, comprising: according to the fuzziness of user temperature perception, using a predicted average voting index (PAVI) as a criterion for evaluating thermal comfort of indoor environment; there is a time-coupling relationship between thermal power of the thermal load and an indoor temperature, when the indoor temperature is allowed to fluctuate within a comfort range, the thermal power has certain elasticity, and by setting a range of the PAVI, obtaining a minimum indoor temperature and a maximum indoor temperature of the heat load;
a relationship between the PAVI and temperature is as follows:
$${λ}_{PMV} = \{ \begin{matrix}0.3895 ( {T}_{in , t} - 26 ) , & {T}_{in , t} \geq 26 \\ 0.4065 ( 26 - {T}_{in , t} ) , & {T}_{in , t} < 26\end{matrix}$$
wherein, λ_{PMV} is value of the PAVI; T_{in,t} is indoor temperature of building at the time t;
implementing as follows:

| Cold/hot | | Relatively | Slightly | | Slightly | Relatively | |
|---|---|---|---|---|---|---|---|
| somatosensory | Hot | hot | hot | Comfort | cold | cold | Cold |
| PAVI | 3 | 2 | 1 | 0 | −1 | −2 | −3 |

according to the table above, obtaining minimum indoor temperature
$${T}_{in , t}^{lb}$$
and maximum indoor temperature
$${T}_{in , t}^{ub}$$
of the heat load by the relationship between the PAVI and the temperature, and obtaining a minimum heating power
$${P}_{lb , t}^{h}$$
and a maximum heating power
$${P}_{ub , t}^{h}$$
of the thermal load of system in a whole dispatching period according to a formula of thermal load power relationship of indoor air temperature; wherein, the formula of the thermal load power relationship of the indoor air temperature is:
$${P}_{L , t}^{h} = \frac{1}{R} ( \frac{{T}_{in , t + 1} - {T}_{in , t} {e}^{- Δ t / τ}}{1 - {e}^{- Δ t / τ}} - {T}_{out , t} ) ;$$
wherein,
$${P}_{L , t}^{h}$$
is thermal load power at the time t, Δt is a minimum dispatch period, e is natural base, R is an equivalent thermal resistance of the building, and T_{in,t} is the indoor temperature of the building at the time t.

4. The optimization scheduling method for the coupling microgrid considering electro-thermal load demand coordination according to claim 1, wherein obtaining the heat balance relationship without considering the flexibility of heat load, and based on the analysis of electro-thermal load demand coordination response strategy, obtaining the coordination mode of electrical and thermal power demand response under the peaking demand, comprising a low load period, a peak load period, and an average load period.

5. The optimization scheduling method for the coupling microgrid considering electro-thermal load demand coordination according to claim 1, wherein the total cost comprises an equipment acquisition cost, an operation-maintenance cost, a cost of hydrogen production water, a hydrogen purchase cost and a transaction cost with external power and gas grids; the constraint conditions comprises a renewable new energy generator unit output constraint, an electro-hydrogen coupling unit operation constraint, a heat generation unit operation constraint, a storage operating constraint, an electrical power balancing, a thermal power balancing, a natural gas balancing, and a hydrogen balancing.

6. An optimization scheduling system for a coupling microgrid considering electro-thermal load demand coordination, applying to execute the optimization scheduling method for the coupling microgrid considering electro-thermal load demand coordination according to any one of claims 1 to 5, comprising:
a model building module, for building a hydrogen-containing microgrid operation model based on operation characteristics and interaction of new energy generating units, electro-hydrogen coupling units, heat generating units and energy storage units; and, building an electro-thermal load demand coordination response model by considering peak-valley complementary characteristics of an original electric load and a thermal load in system;
a demand coordination response optimization module, for characterizing an electric load by a time-of-use price demand response method, by considering a thermal load has heat transfer inertia and fuzziness of user temperature perception, adjusting electro-thermal load demand flexibly based on different electricity prices; and
an operation scheduling module, for based on the hydrogen-containing microgrid operation model and the electro-thermal load demand coordination response model, building an objective function with an objective of minimizing a sum of a total operation cost of a microgrid in the future, a wind and light curtailed cost of renewable energy and a demand response compensation cost, building an electro-hydrogen coupling microgrid optimal scheduling model according to constraint conditions, then solving the electro-hydrogen coupling microgrid optimal scheduling model by a mixed integer linear programming (MILP), and applying a solved optimal operation scheduling strategy to the coupling microgrid for executing.

7. A non-transitory computer-readable storage medium, having computer instructions stored thereon, wherein when the computer instructions are executed by a processor, causing the processor to implement the optimization scheduling method for the coupling microgrid considering electro-thermal load demand coordination according to any one of claims 1 to 5.

8. An electronic equipment, comprising a processor, a memory and a computer program, wherein the processor is connecting to the memory, the computer program is stored in the memory, and when the electronic equipment runs, the processor executes the computer program stored in the memory, causing the electronic equipment to execute the optimization scheduling method for the coupling microgrid considering electro-thermal load demand coordination according to any one of claims 1 to 5.
